(19) United States
(12) Patent Application Publication
(10) Pub. No.: US 2012/0042233 A1
(43) Pub. Date: Feb. 16, 2012

(54) INFORMATION PROCESSING APPARATUS, INFORMATION PROCESSING METHOD AND NON-TRANSITORY COMPUTER READABLE RECORDING MEDIUM

(75) Inventor: Masafumi CHIKYU, Kanagawa (JP)

(73) Assignee: FUJI XEROX CO., LTD., Tokyo (JP)

(21) Appl. No.: 13/018,943

(22) Filed: Feb. 1, 2011

(30) Foreign Application Priority Data
Aug. 12, 2010 (JP) 2010-181019

(51) Int. Cl. G06F 17/21

(52) U.S. Cl. 715/211; 715/273

(57) ABSTRACT

An information processing apparatus includes a vector data acquiring unit, a partial vector data generating unit, and a partial image data generating unit. The vector data acquiring unit acquires vector data contained in image data representing a document image. The partial vector data generating unit generates plural pieces of partial vector data for drawing respective parts into which a drawing target based on the vector data is divided. The partial image data generating unit generates plural pieces of partial image data which include the plural pieces of partial vector data and which constitute the document image.

### CROSS-REFERENCE TO RELATED APPLICATIONS

This application is based on and claims priority under 35 USC 119 from Japanese Patent Application No. 2010-181019 filed on Aug. 12, 2010.

### BACKGROUND

1. Field of the Invention

The present disclosure relates to an information processing apparatus, an information processing method, and a non-transitory computer readable recording medium.

2. Related Art

There is an information processing apparatus which generates display data based on image data stored in a storage section and displays the image data on a display. In the case where display data indicating a part of document images in the image data is displayed on the display, among vector data indicating objects contained in the image data, a rasterizing process is performed for vector data which is determined to be necessary in generation of the display data, to thereby generate bitmap data. By combining the generated bitmap data, the display data is generated and displayed on the display.

### SUMMARY

An information processing apparatus includes a vector data acquiring unit, a partial vector data generating unit, and a partial image data generating unit. The vector data acquiring unit acquires vector data contained in image data representing a document image. The partial vector data generating unit generates plural pieces of partial vector data for drawing respective parts into which a drawing target based on the vector data is divided. The partial image data generating unit generates plural pieces of partial image data which include the plural pieces of partial vector data and which constitute the document image.

### BRIEF DESCRIPTION OF THE DRAWINGS

Exemplary embodiments of the invention will be described in detail based on the accompanying drawings, wherein:

FIG. 1 is a diagram showing the configuration of an information processing apparatus according to one exemplary embodiment;

FIG. 2 is a diagram showing a document image which is based on image data to be processed by the information processing apparatus according to the exemplary embodiment;

FIG. 3 is a diagram showing details of a process of generating a partial image data in the information processing apparatus according to the exemplary embodiment;

FIG. 4 is a diagram showing details of the process of generating the partial image data in the information processing apparatus according to the exemplary embodiment;

FIG. 5 is a diagram showing a drawing determination process in the information processing apparatus according to the exemplary embodiment;

FIG. 6 is a flowchart of the process of generating the partial image data in the information processing apparatus according to the exemplary embodiment;

FIG. 7 is a flowchart of an image displaying process in the information processing apparatus according to the exemplary embodiment;

FIG. 8 is a flowchart of a display range changing process in the information processing apparatus according to the exemplary embodiment;

FIG. 9 is a diagram indicating a drawing determination process according to a comparative example; and

FIG. 10 is a diagram indicating an example of the drawing determination process in the information processing apparatus according to the exemplary embodiment.

### DETAILED DESCRIPTION

Exemplary embodiments of the invention will be described below with reference to the accompanying drawings.

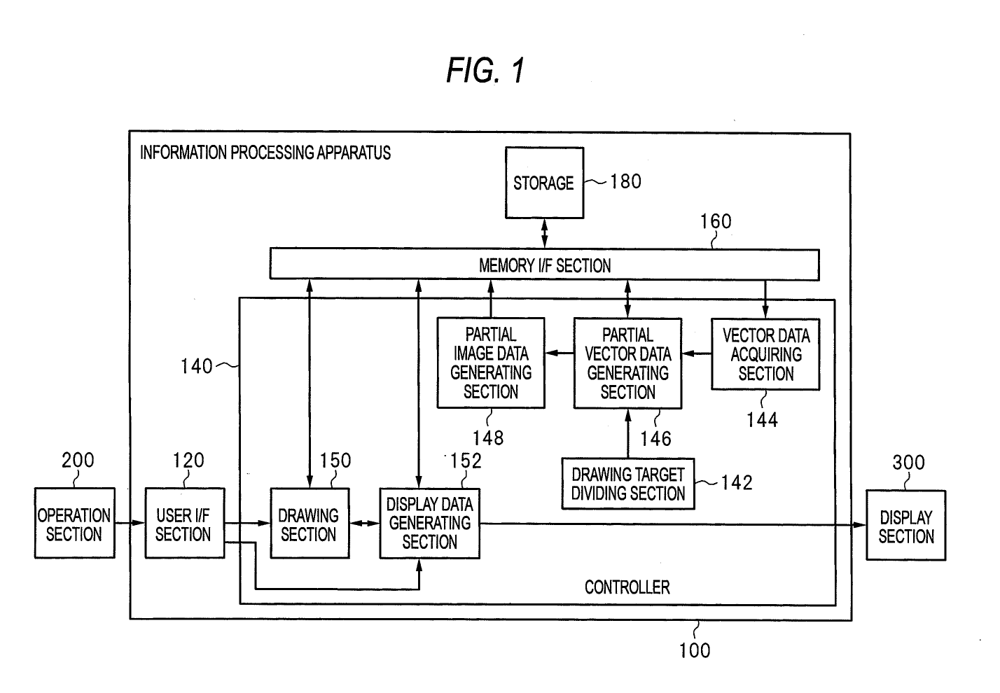

FIG. 1 is a diagram showing the configuration of an information processing apparatus 100 according to an exemplary embodiment. The information processing apparatus 100 is, for example, a desktop PC or a laptop PC.

The information processing apparatus 100 generates display data indicating a part of document images of image data stored in a storage 180, and displays the display data on a display section 300. Hereinafter, the image data will be described.

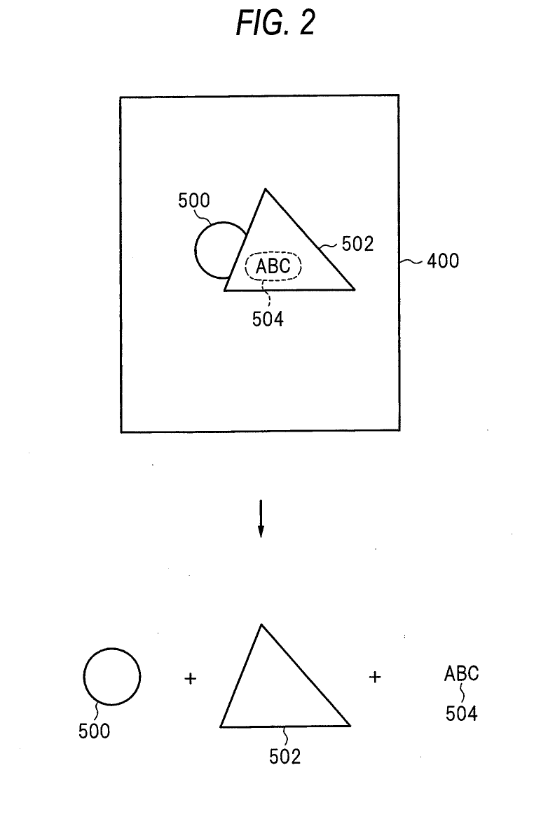

FIG. 2 is a diagram showing a document image 400 which is based on image data to be processed by the information processing apparatus 100 according to the exemplary embodiment. The document image 400 is represented by a combination of objects 500, 502 and 504 which are what is to be displayed. The objects 500, 502, 504 are represented in a format of vector data indicating coordinates and shapes of the respective objects. The image data stored in the storage 180 of the information processing apparatus 100 contains the vector data. When the document image 400 is displayed on the display section 300, the information processing apparatus 100 generates bitmap data in which actual object data is drawn based on the vector data, and combines the bitmap data to generate the actually displayed document image 400.

The information processing apparatus 100 according to the exemplary embodiment divides at least a part of the objects 500, 502 and 504, to generate partial vector data which is used to draw each part (document image piece). The information processing apparatus 100 generates partial image data as image data containing these partial vector data. When the document image 400 is displayed on the display section 300, the partial image data is used.

Next, the information processing apparatus 100 will be described. The information processing apparatus 100 is connected to an operation section 200 and the display section 300. The operation section 200 may be an input device such as keyboards, a mouse, and/or a touch panel in the exemplary embodiment. The display section 300 may be a display device in the exemplary embodiment.

The information processing apparatus 100 includes a user I/F section 120, a controller 140, a memory I/F section 160, and the storage 180. The user I/F section 120, the controller 140, and the memory I/F section 160 may be implemented by one function of CPU. The storage 180 may be implemented by a memory in the exemplary embodiment.

The user I/F section 120 acquires a signal based on operation performed for the operation section 200, and outputs the acquired signal to the controller 140. The memory I/F section 160 acquires a signal input from the controller 140 and outputs the acquired signal to the storage 180, and outputs a signal input from the storage 180 to the controller 140.

The controller 140 controls the information processing apparatus 100 and performs a data process which will be described later. The controller 140 includes a drawing target dividing section 142, a vector data acquiring section 144, a partial vector data generating section 146, a partial image data generating section 148, a drawing section 150, and a display data generating section 152. The storage 180 stores the image data, the partial image data and the like.

Then, an operation of the information processing apparatus 100 will be described. The information processing apparatus 100 acquires vector data from the image data which represents the document image 400 and which is stored in the storage 180, and generates the partial vector data. The information processing apparatus 100 generates plural pieces of partial image data from the partial vector data, and displays the document image 400 using at least one of the plural pieces of partial image data. A process of generating the partial image data will be described below.

The storage 180 of the information processing apparatus 100 stores the image data representing the document image 400. The image data may be generated by the information processing apparatus 100. Alternatively, the image data may be input from another information processing apparatus thereto through a network.

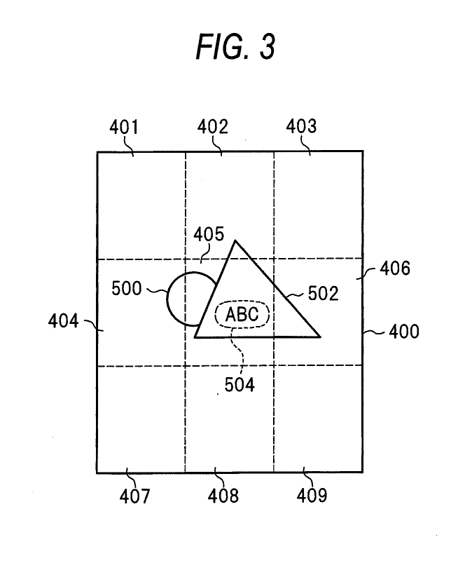

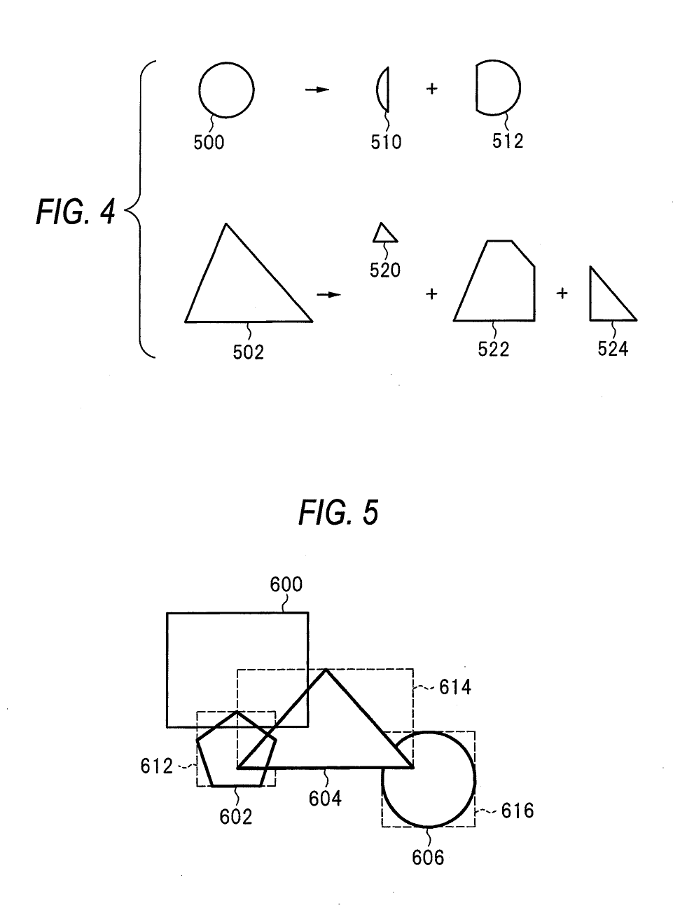

FIGS. 3 and 4 are diagrams showing details of the process of generating the partial image data in the information processing apparatus 100 according to the exemplary embodiment. In the process of generating the partial image data, at first, the drawing target dividing section 142 divides the document images 400, which is drawn based on the image data and defines document image pieces 401 to 409. Each of the document image pieces 401 to 409 has a shape and a size which correspond to display contents (for example, a shape of a display device) in the display section 300.

Then, the vector data acquisition part 144 acquires, from image data stored in the storage 180, vector data contained in the image data. For each acquired vector data, the partial vector data generating section 146 confirms if an object to be drawn has a shape spreading over plural document image pieces among the document image pieces 401 to 409, and determines vector data drawing an object having such a shape to be a target of data division (which will be referred to as “division target vector data”). In the example of FIG. 3, vector data drawing the objects 500 and 502 are determined to the division target vector data. On the other hand, the partial vector data generating section 146 determines vector data, which don't have a shape spreading over plural document image pieces among the document image pieces 401 to 409, to be a non-division target vector data.

Then, the partial vector data generating section 146 divides the division target vector data. The partial vector data generating section 146 generates, from the division target vector data, partial vector data for drawing objects having shapes of respective parts into which an object drawn based on the division target vector data is cut by interfaces between document images pieces 401 to 409. In the example of FIG. 3, the object 500, which is determined to be the division target vector data is divided into objects 510 and 512 shown in FIG. 4. That is, the partial vector data generating section 146 generates partial vector data representing the objects 510 and 512 from the vector data representing the object 500. Likewise, the object 502 is divided into objects 520, 522 and 524 shown in FIG. 4. That is, the partial vector data generating section 146 generates partial vector data representing the objects 520, 522 and 524 from the vector data representing the object 502.

The partial image data generating section 148 generates plural pieces of partial image data which contain the partial vector data generated by the partial vector data generating section 146 and which constitute the document image based on the image data, and then writes the plural pieces of partial image data into the storage 180. Then, the process of generating the partial image data is terminated. The process of generating the partial image data may be performed based on user's operation of the operation section 200 of the information processing apparatus 100. Alternatively, the process of generating the partial image data may be performed at a time when image data is written into the storage 180. Further alternatively, it may be periodically checked whether or not there is new image data in the storage 180, and then the process of generating the partial image data may be performed for the new image data.

Also, the information processing apparatus 100 performs an image displaying process of displaying, on the display section 300, display data which is generated from the partial image data stored in the storage 180, based on user's operation of the operation section 200. The image displaying process will be described below.

When an operation of issuing a command to display image data is performed through the operation section 200, the drawing section 150 defines a partial region of the document image 400 of the image data as a drawing target range 600. Herein, the drawing target range 600 is a range obtained by adding, to a range actually displayed on the display section 300, a predetermined region which is in the surrounding of the range.

Then, the drawing section 150 performs a drawing determination process of determining vector data and partial vector data which are necessary in generation of display data of the drawing target range 600. FIG. 5 is a diagram showing the drawing determination process in the information processing apparatus 100 according to the exemplary embodiment. First, the drawing section 150 acquires vector data and partial vector data which are contained in partial image data. Then, the drawing section 150 performs the drawing determination process for all of objects 602, 604 and 606 which are drawn based on the vector data and the partial vector data. At first, for each of the objects 602, 604 and 606, the drawing section 150 defines bounding boxes 612, 614 and 616 which circumscribe the respective objects as boundaries between regions including the respective objects and their surrounding regions. The drawing section 150 extracts, from the bounding boxes 612, 614 and 616, a bounding box at least a part of which overlaps the drawing target range 600, and determines vector data and partial vector data which draw an object corresponding to the extracted bounding box to be the vector data and partial vector data which are necessary in generation of the display data. In FIG. 5, vector data (and/or partial vector data) drawing the objects 602 and 604 are determined to be the vector data (and/or partial vector data) which are necessary in generation of the display data.

Then, the drawing section 150 generates bitmap data from the vector data and the partial vector data which are determined to be used in generation of the display data, and generates the display data by combining them. The display data generating section 152 acquires the display data generated by the drawing section 150, and displays the display data on the display section 300 except the above-described predetermined range of that display data.

Furthermore, when a user of the information processing apparatus 100 operates to change a display range of the display data displayed on the display section 300, such as scrolling, the display data generating section 152 determines as to whether or not a newly designated display range is included in the already acquired display data (whether or not a scroll range is within the predetermined range). If the newly designated part is included in display data, the display data generating section 152 displays a part of the of display data corresponding to the new display range on the display section 300.

On the other hand, if the newly designated part is not included in the display data (that is, the newly designated part includes a region outside the drawing target range 600), the display data generating section 152 outputs a signal of requiring re-drawing to the drawing section 150. Upon input of the signal requiring re-drawing, the drawing section 150 defines a region obtained by adding a predetermined region to the surroundings of the newly designated part as a new drawing target range 600, and performs the process of generating the display data again. That is, the drawing section 150 determines vector data and partial vector data which are used in generation of the display data again, and acquires determined data from the storage 180. With regard to the already acquired data, the drawing section 150 may not acquire such data from the storage 180 again, but may use the already acquired data. Then, the drawing section 150 generates display data using these data and outputs it to the display data generating section 152. The display data generating section 152 displays a part of the input display data corresponding to the new display range on the display section 300.

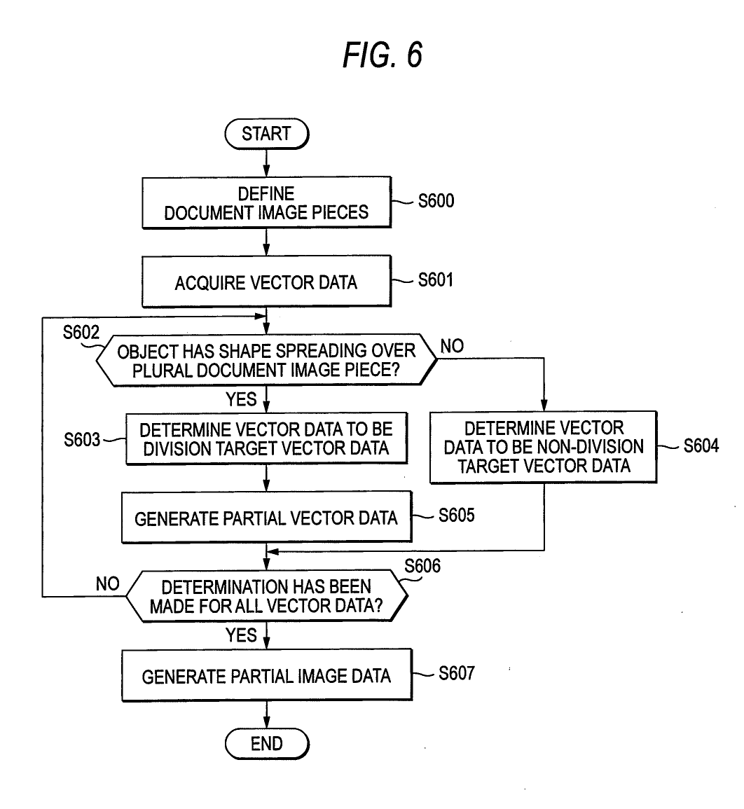

Then, an operation of the information processing apparatus 100 will be described with reference to a flowchart. FIG. 6 is a flowchart showing the process of generating partial image data in the information processing apparatus 100 according to the exemplary embodiment.

First, the drawing target dividing section 142 divides the document image 400, which is displayed based on the image data to define the document image pieces 401 to 409 (S600). Then, the vector data acquiring section 144 acquires vector data from the image data stored in the storage 180 (S601). The partial vector data generating section 146 checks as to whether or not an object which is drawn based on the vector data acquired in S601 has a shape spreading over plural document image pieces of the document image pieces 401 to 409 (S602), and determines the vector data drawing the object having such a shape to be division target vector data which is to be subjected to the data division (S603). On the other hand, the partial vector data generating section 146 determines that vector data drawing an object which doesn't have a shape spreading over plural document image pieces of the document image pieces 401 to 409 is vector data which does not need to be subject to the data division (non-division target vector data) (S604).

Then, the partial vector data generating section 146 performs the division process for the vector data which is determined to be the division target vector data in S603, and generates the partial vector data (S605). The processes at S602 to S605 are performed for all of the vector data generated in S601 (S606). Then, the partial image data generating section 148 generates the partial image data from the partial vector data generated in S605 and the non-division target vector data, and saves in the storage 180 (S607). Then, the process of generating the partial image data is terminated.

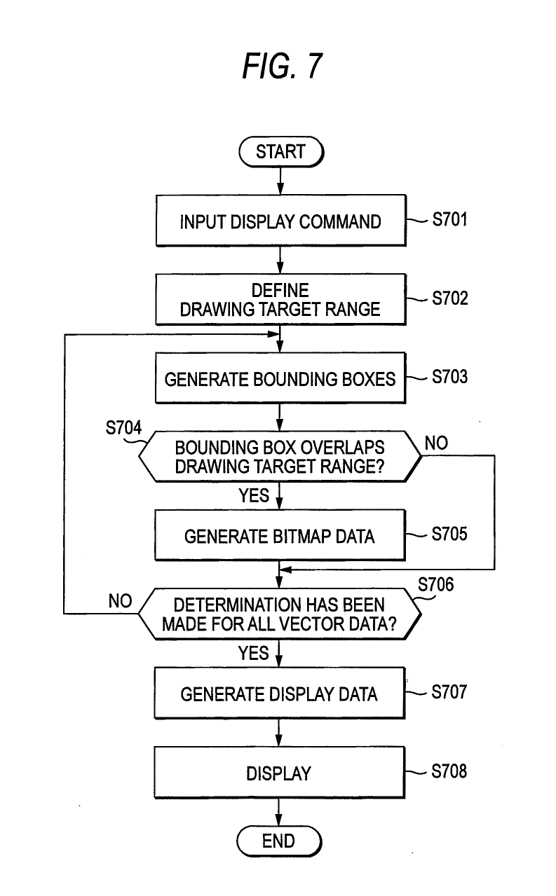

Next, the process of generating the display data in the information processing apparatus 100 will be described. FIG. 7 is a flowchart showing an image displaying process in the information processing apparatus 100 according to the exemplary embodiment.

When a user designates any of the image data (it is assumed that partial image data are generated) stored in the storage 180 and operates, to issue a command to display the designated image data (S701), the drawing section 150 defines a part of contents which are drawn based on the designated image data as a drawing target range 600 (S702). Then, for all of vector data or partial vector data drawing objects included in the image data, the drawing section 150 generates information indicating ranges of bounding boxes of the drawn objects (S703). For each of the bounding boxes, the drawing section 150 determines as to whether or not at least a part of each bounding box overlaps the drawing target range 600 defined in S702 (S704).

Then, the drawing section 150 generates bitmap data from the vector data and the partial vector data, which are determined to overlap the drawing target range 600 in S704 (S705). The drawing section 150 executes such a process for all of the vector data drawing the designated image data (S706). After executing the processes of S703 to S705 for all the vector data, the drawing section 150 combines all the bitmap data generated in S705, and generates display data (S707). The display data generating section 152 acquires the display data generated in S707, and displays a region of the display data on the display section 300 except the predetermined range (S708). Accordingly, the image displaying process is terminated.

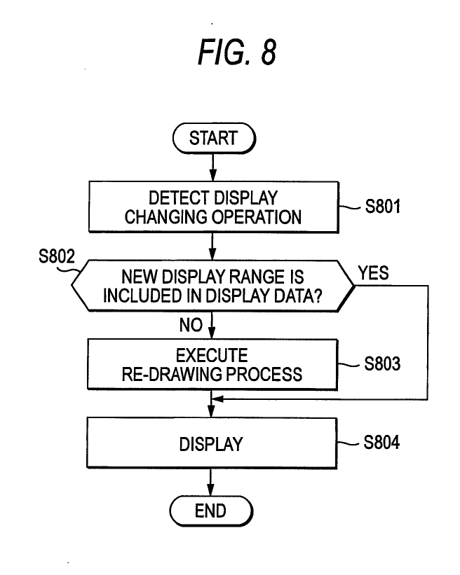

Next, the display range changing process such as scroll will be described. FIG. 8 is a flowchart showing the display range changing process in the information processing apparatus 100 according to the exemplary embodiment. It is assumed that the display section 300 of the information processing apparatus 100 already displays certain display data. When detecting a display range changing operation which instructs to change a display range (e.g. scroll) (S801), the display data generating section 152 of the information processing apparatus 100 determines as to whether or not a newly designated display range is included in the already acquired display data (hereafter, referred to as “old display data”) (S802).

If the newly designated part is not included in the old display data, the display data generating section 152 outputs a signal requiring re-drawing to the drawing section 150. Then, the drawing section 150 defines a range obtained by adding a predetermined region to the surrounding of the newly designated part as a new drawing target range 600, performs the process of generating display data (hereafter, referred to as “new display data”) (re-drawing process) (S803), and outputs the new display data to the display data generating section 152.

Then, the display data generating section 152 displays a part corresponding to a new display range of the new display data on the display section 300 (S804). Herein, if it is determined in S802 that the newly designated part is not included in the old display data, the new display data generated in S803 is used as display data, and if it is determined in S802 that the newly designated part is included in the old display data, the old display data is used as display data. Accordingly, the display range changing process is terminated.

With the above-described configuration, plural pieces of partial image data are generated which include plural pieces of partial vector data, generated from vector data included in image data and drawing respective parts into which a drawing target based on the vector data is divided, and which constitute a document image based on the image data. Data which is processed when contents of the image data are displayed on the display section 300 is not vector data as in a related art, but the vector data or the partial vector data. Therefore, an amount of the data can be suppressed to be smaller than that in the related art. As a result, a process amount in generation of the display data and a memory area used can be suppressed to be small.

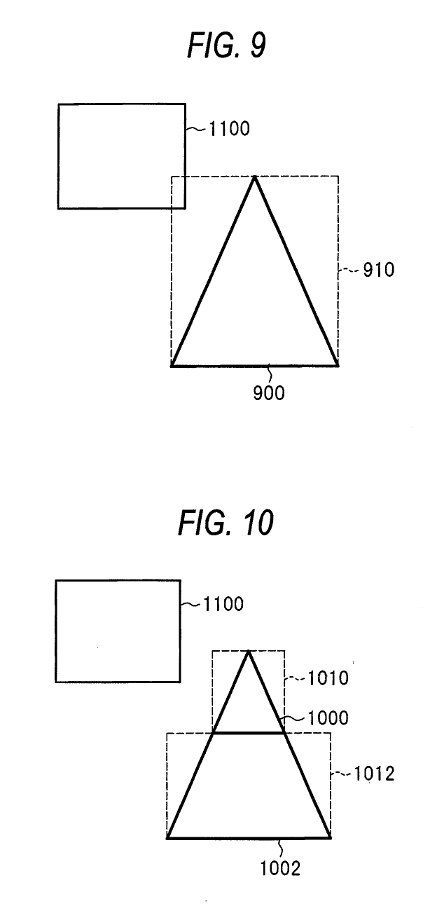

Also, in a comparative example (which will be detailed later) in which determination is made based on bounding boxes, there is a possibility that an object which does not need to be drawn may be determined to be an object which needs to be drawn. The exemplary embodiments can reduce this possibility. This advantage will be described in detail below. FIG. 9 is a diagram showing a drawing determination process according to a comparative example. Herein, an object 900 defines a bounding box 910. In the comparative example shown in FIG. 9, since the object 900 does not overlap a drawing target range 1100, but the bounding box 910 overlaps the drawing target range 1100, it is determined that drawing is necessary, and a process of drawing an object is performed. FIG. 10 is a diagram showing an example of the drawing determination process in the information processing apparatus 100 according to the exemplary embodiment. Herein, objects 1000 and 1002, in combination, have the same shape as the object 900 of FIG. 9. However, as a result of being divided into the objects 1000 and 1002 by the partial vector data generating section 146, defined bounding boxes 1010 and 1012 don't overlap the drawing target range 1100. In this manner, it can be avoided that an object actually unnecessary to be drawn is determined to be an object which needs to be drawn. Therefore, the processed data amount can be reduced as compared with the comparative example. Also, as to objects which actually need to be drawn, the data amount of vector data is smaller than that before division. In view of this point, the processed data amount is reduced as compared with the comparative example.

The information processing apparatus 100 is an information processing apparatus such as a PC, and may be implemented by executing a program stored in a memory of the information processing apparatus. The program may be provided through a communication. Alternatively, the program may be stored in a storage medium such a CD-ROM readable by a computer.

In the exemplary embodiment, the one and same information processing apparatus 100 performs the process of generating partial image data and the image displaying process. However, the respective processes may be performed in separate apparatuses. For example, a host computer may executes the process of dividing vector data, and a portable information terminal connected to the host computer may acquire the vector data and partial vector data from the host computer and then perform the image displaying process.

Also, in the exemplary embodiment, the partial vector data generating section 146 determines as to whether or not each vector data is division target vector data, based on whether or not an object has a shape spreading over plural regions of the document image pieces 401 to 409. However, this determination may be made based on predefined other conditions. For example, vector data having a data amount which is larger than a predetermined amount may be divided. Alternatively, whether or not vector data is divided and how many pieces the vector data is divided into may be determined based on an area of an object which is drawn based on the vector data. Further alternatively, considering a shape of an object to be drawn, vector data may be divided so as to exclude a region where no object exists. Also, the shapes of the document image pieces 401 to 409 in the exemplary embodiment may be determined based on information indicating a process power of the display data generating section 152.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a vector data acquiring unit that acquires vector data contained in image data representing a document image;
a partial vector data generating unit that generates plural pieces of partial vector data for drawing respective parts into which a drawing target based on the vector data is divided; and
a partial image data generating unit that generates plural pieces of partial image data which include the plural pieces of partial vector data and which constitute the document image.

2. The apparatus according to claim 1, wherein
at least one of the plural pieces of partial image data is used in a display process, executed by a display unit, of the document image, and
the partial vector data generating unit divides the drawing target based on information relating to the display process.

3. The apparatus according to claim 1, wherein
with regard to the vector data satisfying a predetermined condition, the partial vector data generating unit generates the partial vector data.

4. The apparatus according to claim 3, wherein
with regard to the vector data having a data amount which is larger than a predetermined amount, the partial vector data generating unit generates the partial vector data.

5. The apparatus according to claim 2, wherein
with regard to the vector data satisfying a predetermined condition, the partial vector data generating unit generates the partial vector data.

6. The apparatus according to claim 5, wherein
with regard to the vector data having a data amount which is larger than a predetermined amount, the partial vector data generating unit generates the partial vector data.

7. An information processing method comprising:
acquiring vector data contained in image data representing a document image;
generating plural pieces of partial vector data for drawing respective parts into which a drawing target based on the vector data is divided; and
generating plural pieces of partial image data which include the plural pieces of partial vector data and which constitute the document image.

8. A non-transitory computer readable recording medium storing a program that causes a computer to execute information processing, the information processing comprising:
acquiring vector data contained in image data representing a document image;
generating plural pieces of partial vector data for drawing respective parts into which a drawing target based on the vector data is divided; and
generating plural pieces of partial image data which include the plural pieces of partial vector data and which constitute the document image.
